(19) United States
(12) Patent Application Publication
(10) Pub. No.: US 2009/0122346 A1
(43) Pub. Date: May 14, 2009

(54) IMAGE FORMING APPARATUS

(76) Inventor: Yoshihisa KAMATA, Hadano-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/268,778

(22) Filed: Nov. 11, 2008

(30) Foreign Application Priority Data
Nov. 14, 2007 (JP) JP2007-295416

(51) Int. Cl. G06K 15/00

(52) U.S. Cl. 358/1.16

(57) ABSTRACT

An image read-out through a scanner section is stored in a memory device 69 as an image for test print. When a job is inputted, selection of the image used for the test print among images registered in advance and designation of a test print cycle are received form the user. During execution of the job, when a sample timing arrives or a manual test print instruction is received, the test print is carried out in a way that the image designated for the test print is formed on a sheet, and the sheet is ejected to a sub-tray.

This application is based on Japanese Patent Application No. 2007-295416 filed on Nov. 14, 2007, in Japanese Patent Office, the entire content of which is hereby incorporated by reference.

### TECHNICAL FIELD

The present invention relates to an image forming apparatus such as copying machine and printing apparatus, and in particular, to an image forming apparatus capable of test print where a sheet on which an image is formed is ejected to a second sheet ejection section, before, during or after consecutive ordinary print where the sheet on which the image is formed is ejected to a first ejection section.

### BACKGROUND OF THE INVENTION

In case a large amount of printing or copying is carried out consecutively or in case color printing where a quality of an linage tends to readily change is carried out, it is preferred to check occasionally if a good image quality is maintained. However, a stacker device used as a destination of sheet ejection for a large amount of prints is often disposed at a place where the prints cannot be observed from outside. Thus by opening a door of the stacker to confirm the quality of the image, productivity is deteriorated since the printing operation is temporally interrupted.

Therefore, there is provided an image forming apparatus configured to execute the test print to eject the sheet to the second sheet ejection section while executing printing operation, where the sheet is ejected to the first sheet ejection section when a user operates a test print button or at a test print cycle having been set (at every set number of prints) (for example, refer to Unexamined Japanese Patent Application Publication No. 2005-153374).

Among pages belong to a print job, an image of a page being printed at a time point where an execution timing of the test print cones is generally, diverted as the image for the test print as it is, as the image for the test print, among pages belong to a print job. For example, in case the test print is carried out subsequent to printing of a sixth page in the printing job, the image of the sixth page is used for the test print.

Also, there is provided a digital printing apparatus which carries out the test print for one booklet after outputting a booklet currently outputted by replacing the sheet ejection tray with a sheet ejection tray for the test print when an instruction of the test print execution is received from an operator during printing a booklet (Unexamined Japanese Patent Application Publication No. 2004-284323).

Apart from the above apparatuses, there is provided an apparatus to automatically output a fixed test pattern for color when printing in color and a fixed test pattern for monochrome when printing in monochrome without changing the sheet ejection destination (For example, Unexamined Japanese Patent Application publication No. H08-197779).

Patent Document 1: Unexamined Japanese Patent Application Publication No. 2005-153374

Patent Document 2: Unexamined Japanese Patent Application Publication No. 2004-284323

Patent Document 3: Unexamined Japanese Patent Application Publication No. H08-197779

In the foregoing, since the image in the printing job is diverted for the image for the test print, there have been cases that the image might not be suitable for checking the image quality, and the image might not be an image to be expected by the user as the test print.

Also, the fixed test patter made by a maker provided inside the apparatus in advance is configured with complicated patters and color charts in order to check all items of image quality and color. Thus, for example, there has been a problem that for the user who requires test print to check only taint of the sheet, toner consumption increases needlessly.

Also, the user who uses the printing machine tends to use an exclusive test chart to suite the contents to be check, and in the test print, there has been a problem that the fixed chart provided by the maker was not able to satisfy such demands of the user.

### SUMMARY

To provide an image forming apparatus capable of the test print using a discretionary image desired by the user, the present invention is provided with the following structures:

An image forming apparatus, having;

an image forming section to form and output an image on a sheet;

a first sheet ejection section to receive the sheet outputted from the image forming section;

a second sheet ejection section to receive the sheet outputted from the image forming section;

an ejected sheet destination changeover section to change a destination of an ejected sheet from the image forming section between the first ejection section and the second ejection section;

an image input section to input an image used in the test print; a memory section to store the image inputted through the image input section;

a selection section to select the image used in the test print among the images stored in the memory section; and

a control section to control ordinary print where the sheet on which the image has been formed is ejected to the first sheet ejection section and test print where the image selected by the selection section is formed on the sheet and the sheet thereof is ejected to the second sheet ejection section before, during or after consecutive ordinary print.

In the above configuration, it is possible that the discretionary image inputted via the image input section can be stored in the image storing section and the image used in the test print can be selected from among the images stored in the memory section. The image input section can be configured, for example, so that image data is inputted via communication such as network from an external device such as a scanner to obtain the image data by reading the document optically or from a personal computer.

### BRIEF DESCRIPTION OF THE DRAWINGS

FIG. 1 is an explanatory diagram showing a cross-sectional structure of an image forming apparatus related to the present invention.

FIG. 2(a) to FIG. 2(e) are explanatory diagrams schematically indicating operation states from stacking the sheet at a main stacker section of the stacker device used in the image forming apparatus related to the present invention to bringing out the sheet.

FIG. 3 is a block diagram describing electrical configuration of the image forming apparatus of the present invention.

FIG. 4 is an explanatory diagram describing an exemplary automatic test print by output before job start.

FIG. 5 is an explanatory diagram describing an exemplary automatic test print by output at each designated sheet number.

FIG. 6 is an explanatory diagram describing an exemplary automatic test print by output at sectional deliminater.

FIG. 7 is an explanatory diagram describing an exemplary automatic test print by output after job start.

FIG. 8 is an explanatory diagram describing an exemplary automatic test print in case the ordinary print is temporary interrupted after test print.

FIG. 9 is an explanatory diagram describing an exemplary manual test print.

FIG. 10 is a front view showing an exemplary display of a copy default screen.

FIG. 11 is a front view showing an exemplary display of box selection screen.

FIG. 12 a front view showing an exemplary display of a file name input screen.

FIG. 13 is a front view showing an exemplary display of read-in setting screen.

FIG. 14 is a front view showing an exemplary display of output setting screen.

FIG. 15 is a front view showing an exemplary display of test print setting screen.

FIG. 16 is a front view showing an exemplary display of detail setting screen.

FIG. 17 is a front view showing an exemplary display of chart selection screen.

FIG. 18 is a front view showing an exemplary display of manual test print detail setting screen.

FIG. 19 is a front view showing an exemplary display of a screen of printing

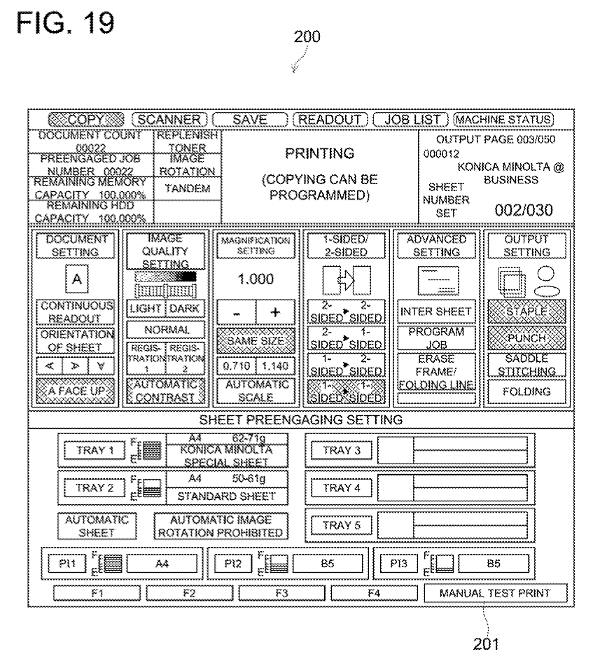

FIG. 20 is a flow chart indicating total operation of an image forming apparatus to execute a job.

FIG. 21 is a flow chart indicating a test print image preparation process.

FIG. 22 is a flow chart indicating a sheet feeding process.

FIG. 23 is a flow chart indicating an automatic test print execution judging process

FIG. 24 is a flow chart indicating sheet ejection process.

### DETAILED DESCRIPTION OF THE INVENTION

An embodiment of the present invention will be described with reference to the drawings as follow.

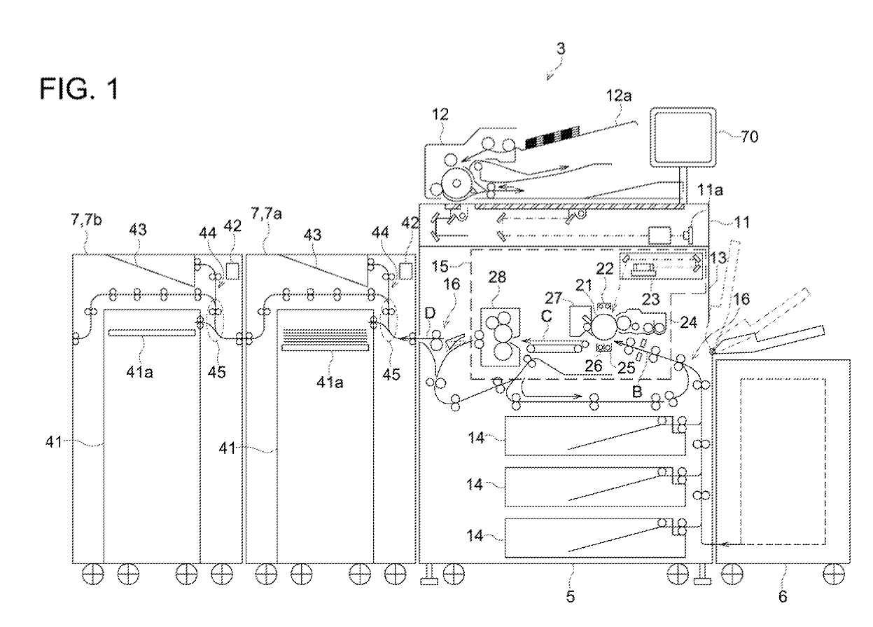

FIG. 1 shows a cross-sectional view of a configuration of an image forming apparatus 3 related to an embodiment of the present invention. The image forming apparatus 3 is configured with an image forming apparatus main body 5, a large capacity sheet feeding apparatus 6 and a stacker apparatus 7 connected to a last stage of the image forming apparatus main body 5. The image forming apparatus 3 is so-called a digital multifunction machine which is provided with a copying function to read a document optically and form a copy image thereof on a sheet and a printing function to received print data from an external deice such as a personal computer and to form and output the corresponding image on the sheet.

The large capacity sheet feeding apparatus 6 is a sheet feeding apparatus capable of storing a large amount of sheets to be fed to the image forming apparatus main body 5. The stacker apparatus 7 is a stacker to stack and accumulate a large number of sheets ejected from the image forming apparatus main body 5. Here two units i.e. a first stacker apparatus 7a and a second stacker apparatus 7b are connected in a cascade. Since the image forming apparatus 3 is provided with the large capacity sheet feeding apparatus 6, the first stacker apparatus 7a and the second stacker apparatus 7b, it can carry out large amount of printing subsequently and is used for so-called shortrun printing.

The image forming apparatus main body S is provided with a scanner section 11 to read a document image, a automatic document feeding deice 12 to feed the documents placed on the document tray 12a piece by piece to a document read position of the scanner section 11, printer section 13 to form and output an image on the sheet and an operation display section 70.

Scanner section 11 is configured with a light source to radiate light onto the document, a line image sensor to read the document in a width direction of the document thereof in one line and an optical pass configured with lenses and mirrors to lead a reflected light from the document to the line image sensor 11a and to form an image. The scanner section 11 can read the document in a flow reading method where an automatic document feeding device 12 conveys the document so that the document is read while moving in respect to a reading position. Also it can read the document by placing the document is on a platen glass. The scanner section 11 serves as an image input section.

Printer section 13 is configured with a plurality of sheet feeding trays 14 to store the sheets for image forming, an image forming section 15 to form an image on the sheet, and a sheet conveyance mechanism 16 to feed sheet from the large capacity sheet feeding apparatus 6 or the sheet feeding tray 14 to pass the sheet through the image forming section 15 and eject the sheet to the first stacker device 7a at a later stage.

The image forming section 15 is configured with a photoconductive substance 21, a charging device 22, a laser unit 23, a developing device 24, a transfer device 25, a separation device 26, a cleaning device 27 and a fixing device 28, and forms the image on the sheet with an electrophotographic process.

Specifically, the photoconductive substance 21 in a shape of a cylinder rotates in a certain direction (The direction A shown by an arrow in the figure) through an unillustrated driving section. While rotating, the photoconductive substance 21 is charged evenly by corona discharging of the charging device 22, thereafter a surface of the photoconductive substance is scanned by a laser beam which turns on and off according to the image data from a laser unit 23 and an electrostatic latent image is formed thereon. The developing device 24 visualizes the electrostatic latent image formed on the surface of the photoconductive substance 21 as a toner image.

The sheet conveyance mechanism 16 feeds the sheet from the large capacity sheet feeding apparatus 6 or the sheet feeding tray 14 and conveys it so as to sent it between the photoconductive substance 21 and the transfer device 25 at an appropriate timing (arrow B). The transfer device 25 electrostatistically transfers the toner image formed on the surface of the photoconductive substance 21 onto the sheet conveyed through the sheet transfer mechanism 16, and the separation device 26 separates the sheet from the photoconductive substance 21 by discharging. After transferring, the cleaning device 27 removes the remaining toner on the photoconductive substance 21 by rubbing with a blade. The sheet on which the toner image has been transferred is further conveyed (arrow C) and heated when it passes through the fixing device 28 so as to fix the toner image on the sheet. Thereafter the sheet is ejected to the first stacker device 7 (Arrow D). Meanwhile, the image forming section 15 can be other method to form the image on the sheet than the electrophotographic method.

The first stacker device 7a is equipped with a main stacker section 41 as the first sheet ejection section having a stage 41a which elevates in accordance with an amount of the stacked sheet and configured to be able to stack a large amount of sheets (for example, 5000 pieces). The main body of the first stacker device 7a is provided with a bring out button 42 which is pressed to bring out the sheet stacked on the main stacker section 41 and an unillustrated door to be opened for sheet bring out. The first stacker device 7a is configured so that the image on the sheet stacked on the main stacker section 41 cannot be observed while receiving the sheet ejected from the image forming apparatus main body 5, since the first stacker device 7a is used with the door being closed except when the sheet is brought out.

On a top surface of an upper section of the first stacker device 7a, there is provided a sub-tray 43 representing the second sheet ejection section to stack the test printed sheet. The sub-tray 43 is an ejection tray exposed outside and configured so that the image on the stacked sheet can foe observed.

The first stacker device 7a is further provided with a conveyance mechanism 44 to convey an inflowing sheet ejected from the image forming apparatus main body 5 within the apparatus and an ejection destination changeover mechanism (sheet ejection destination changeover section) 45 to change the destination of the sheet thereof to the main stacker section 41, the sub-tray 43 or an apparatus at a later stage.

Since the second stacker device 7b has the same configuration as that of the first stacker device 7a, duplicated descriptions are omitted. Meanwhile, the sheet can be brought out while consecutive image forming is carried out by alternately using the first stacker device 7a and the second stacker device 7b as the destinations of the ejected sheet to be accumulated in such way that the second stacker device 7b is used while the sheet is brought out from the main stacker section 41 of the first stacker device 7a with the door being opened.

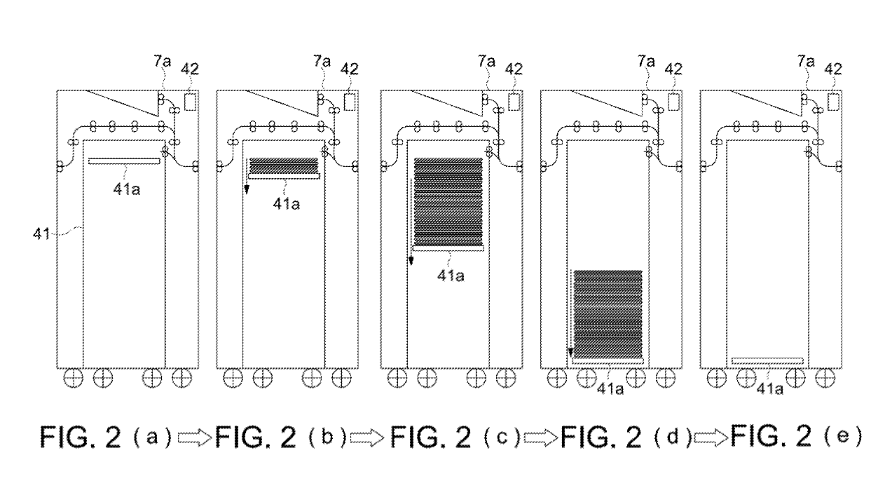

FIG. 2(a) to FIG. 2(e) schematically show operation states of the first stacker device 7a from stacking sheet on the main stacker section 41 to bringing out the sheet. As FIG. 2(a) shows the stage 41(a) is at a highest position when the sheet is not stacked on the first stacker device 7a. For example, from this state, the image forming apparatus main body 5 starts printing operation (image forming operation) and the sheet after image forming is ejected to the main stacker section 41 of the first stacker device 7a. Then in accordance with an amount of the sheets stacked, the main stacker section 41 gradually descends as FIGS. 2(b) and 2(e) show so as to keep a height of an uppermost section of the sheets stacked substantially unchanged.

As FIG. 2(c), when the bring out button 42 is pressed while the sheet is being stacked, further reception of the sheet to the main stacker section is interrupted (in case of consecutive image forming is carried out, the inflowing sheets from the image forming apparatus main body 5 is ejected to the second stacker device 7b), thereafter the stage 41a starts descent operation and the stage 41a descends to an lower end as FIG. 2(d) shows.

In this state the user can open the door and remove the sheet in the first stacker deice 7a. As FIG. 2(e) shows, when the sheet is removed from the stage 41a and the door is closed, the first stacker device 7a ascends the stage 41a and returns to the state of FIG. 2(a). As above, the image on the sheet, ejected to the main stacker section 41 cannot be observed while the sheet ejection operation to the main stacker section 41 is being carried out. Therefore, the image forming apparatus 3 is provided with a function to conduct test print in which the sheet after image forming is ejected to the sub-tray 43 before, during or after the ordinary print to subsequently eject the sheet after image forming to the main stacker section 41 by temporally changing the sheet ejection destination to the sub-tray 43.

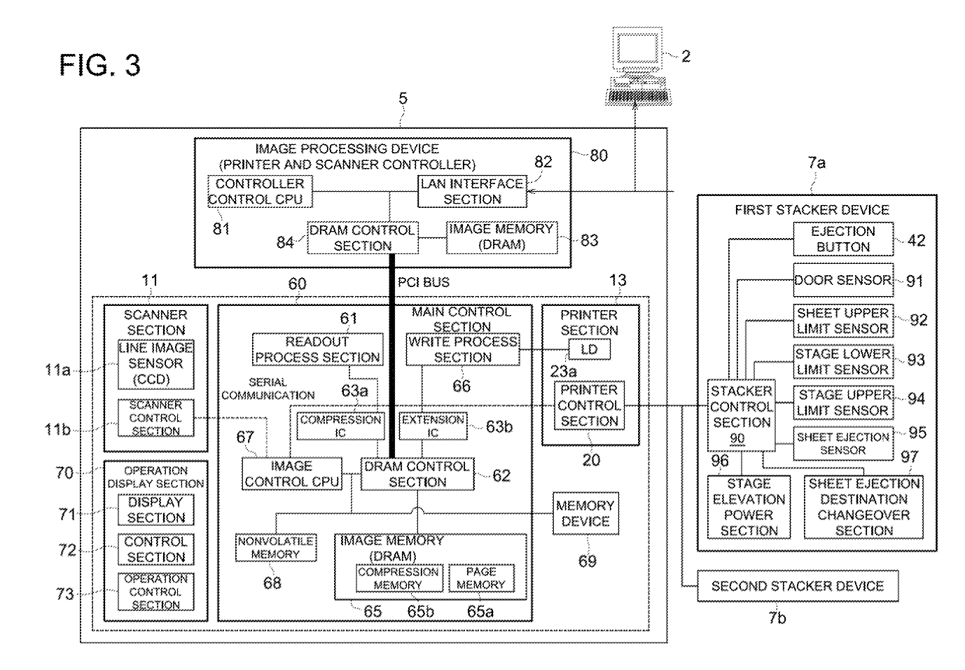

FIG. 3 is a block diagram indicating an electrical configuration of the image forming apparatus main body 5 and the stacker device 7. The image forming apparatus main body 5 is configured by connecting the seamier section 11, the printer section 13, the operation display section 70 and the image processing section 80 to an main control section 60 to control operation of the image forming apparatus main body 5 overall.

The scanner section 11 is provided with a scanner control section 11b to control total operation of the scanner section 11 besides the line image sensor 11a shown in FIG. 1. The printer section 13 is provided with an printer control section 20 to control total operation of the printer section 13 including the image forming section 15 and the sheet conveyance mechanism 16 besides the laser diode (LD) 23a which is turned on and off according to the image data. In addition, an unillustrated motor, a solenoid and a sensor to operate each section of the image forming section 15 and the sheet conveyance mechanism 16 are connected to the printer control section 20.

The operation display section 70 serves a function to display various setting screens and operation screens so as to receive various settings and selection operation from the user, and to display various kinds of information and warning toward the user. The operation display section 70 includes a display section 71 configured with a liquid crystal display, an operation section 72 configured with touch switches and other switches provided on the screen thereof and an operation control section 73 to control operation of the display section 71 and the operation section 72. The operation display section 70 serves as a selection section to receive selected image used in the test, print,

Meanwhile, the scanner control section lib, the operation display section 70, the printer control section 20 are respectively configured with unillustrated circuits having a CPU(Central Processing Unit), a ROM (Read Only Memory) and a RAM (Random Access Memory) as main components and various control is executed in accordance with programs stored in the ROM.

A main control section 60 serves a function to control operation of the image forming apparatus 3 overall and is provided with a read-in process section 61, a DRAM (Dynamic Random Access Memory) control section 62, a compression IC 63a, an expansion IC 63b, an image memory 65, a writing process section 66 an image control CPU 67, a nonvolatile memory 68 and a memory device 69 such as hard disk device. The memory device 69 serves as a memory section to store and register the image used in the test print.

The read-in process section 61 serves a function to apply a binarization process to the image data outputted from the scanner section 11 by a magnification process, a mirror image process and error diffusion. The compression IC 63a serves a function to compress the image data and expansion IC 63b serves a function to expand the compressed image data to be an original image data. The image memory 65 serves as a page memory 65a capable of storing non-compressed image data in units of page and serves as a compression memory 65b to accumulate compressed image data.

The writing process section 66 serves a function to output a signal, which turns on and off the laser diode 23a of the laser unit 23 in accordance with the image data read out from the image memory 65 and expanded, to the laser diode 23a with a timing corresponding to operation of the printer section 13. The DRAM control section 62 performs timing control of read, write and refresh of the image memory 65 configured with a dynamic RAM and timing control when the image data is compressed and stored in the image memory 65, or the compressed data is read out from the image memory 65 and expanded.

The image control CPU 67 is a CPU to control total operation of the image forming apparatus main body 5. The CPU 67 serves functions to manage a flow of the image data and to manage registration of a preengagement of the job and execution of the job. Also it serves as the control section to control test print operation.

The image processing section 80 serves as the print controller to receive print data from an external terminal 2 such as a personal computer and expand the print data to be raster image data, and also serves as the scanner controller to transmit image data obtained by reading out the document through the scanner section 11 via electric mail or FTP (File Transfer Protocol) to the external terminal 2 through a network. The image process section 80 serves as an image input section to input the image for the test print. The image forming apparatus 3 is configured to be able to store an image obtained by expanding the print data with the image process section 80 to be raster image data or an image received via a network as the image for the test print.

The image process section 80 includes a controller control CPU 81 to control the above functions overall, a LANIF section 82 to serve a communication function for connecting with LAN (Local Area Network), an image memory 83 to accumulate image data, and a DRAM control section 84. The DRAM control section 84 conducts timing control of read/write and refresh in respect to an image memory 83 configured with a dynamic RAM. Also, DRAM control section 84 passes image data between a DRAM control section 62 of the main control section 60 via PCI (Peripheral Component Interconnect) bus.

To configure the first stacker device 7a, the bring out button 42, the door sensor 91 to detect open/close of the door to be opened when the sheet stacked on the main stacker section 41 is brought out, a sheet upper limit sensor 92 to detect whether or not the amount of the sheet stacked on the main stacker section 41 reaches to a predetermined upper limit amount, a stage lower limit sensor 93 to detect whether or not a descending position of the stage 41a reaches at an lower limit, a stage upper limit sensor 94 to detect whether or not a ascending position of the stage 41a reaches at an upper limit, a sheet ejection sensor 95 to detect the completion of sheet ejection to the stage 41 a or the sub-tray 43, a stage elevation power source section 95 representing a power source (motor) to elevate the stage 41a, and a sheet ejection destination changeover section 97 configured with a solenoid to operate changeover pawl which changes the sheet ejection destination between the main stacker section 41 and the sub-tray 43, and a drive circuit thereof are connected to the stacker control section 90. Descriptions for the second stacker device 7b are omitted since the configuration thereof is the same as that of the first stacker device 7a.

The stacker control section 90 is connected with the printer control section 20 of the printer section 13 via a signal cable. The image control CPU 67 outputs an instruction to designate (change) the destination of sheet ejection to the printer control section 20, and the printer control section 20 outputs the instruction to change the destination of sheet ejection in synchronization with a sheet ejection timing to the corresponding stacker control section 90.

Next, the operation of the image forming apparatus 3 will be described.

<Copy Operation>

Copy operation is configured by combining a read process in which the scanner section 11 reads the document image and the image data obtained by reading is stored in the image memory 65, and an output process (ordinary print) in which image data stored in the image memory 65 is outputted to the printer section 13 and printed. In the read process, the document image is read optical through the line image sensor 11a of the scanner section 11, and the image data obtained by reading out is inputted to the read out process section 61 and various image processing for read out is applied to it. Thereafter, the image data is inputted to the compression IC 63a via the DRAM control section 62 and compressed. The image data after compression is again stored in the compression IC 65b via the DRAM control section 62. The compressed image data in the compression memory 65b may be transferred to the memory device 69 and stored.

Output processing starts after completion of the read process of document images of all pages. In the output processing, in case the image data to be outputted is stored in the memory device 69, the image data is read out to the image memory 65. The compressed image data in the compression memory 65b is read out through the DRAM control section 62 and expanded by the expansion IC 63b to be temporally stored in the page memory 65a, then sent from the page memory 65a to the writing process section 66 via the DRAM control section 62 and after various image processing is applied, it is outputted to the laser diode 23a of the printer section 13. The printer section 13 forms an image based on the image data sent from the writing process section 66 then the sheet after image forming is ejected to the stacker device 7 in a later stage. The stacker device 7 stacks the sheet on the main stacker section 41.

<A Printing Operation Based on Print Data from an External Terminal>

A printing operation based on print data from an external terminal is configured with a combination of document receiving processing and output processing. In document receiving processing, the print data is inputted to the image processing section 80 from the external terminal 2 via a LAN circuit, and after expanding the print data into the raster image, the image processing section 80 outputs the raster image to the DRAM control section 62 via the PCI bus. The image data via the DRAM control section 62 is compressed by the compression IC 63a and the image data having been compressed goes through the DRAM control section 62 again and then is stored in the compression memory 65b. The compressed image data in the compressed memory 65b may foe transferred to the memory device 69 and stored. The detail of the output processing is the same as that of the copying action thus the description is omitted.

<Test Print Operation>

Test print operation is a series of operation where the sheet ejection destination is changed to the second sheet ejection section (main stacker section 41), before during or after consecutive ordinary print in which the sheet after image forming is ejected to the first sheet ejection section (main stacker section 41), thereafter the sheet ejection destination is returned to the first sheet ejection section (main stacker section 41). Test print operation includes automatic test print and manual test print. The former includes “before job start output” to output a sample (a test print) before the job starts, “output at each designated sheets number” to output the sample periodically at printing of each designated sheets number from start of the job, “output at sectional deliminater” to output the sample at sectional deliminaters, and “after job complete output” to output the sample at completion of job. The later is a manual output to output the sample immediately when an output instruct is received from a user.

The image forming apparatus 3 is capable of storing and registering discretionary images inputted from the image processing section 80 or the scanner section 11 as images (test print images) to be used for the test print in the memory device 69, and capable of selecting and designating the image to be used for the test print among the registered images.

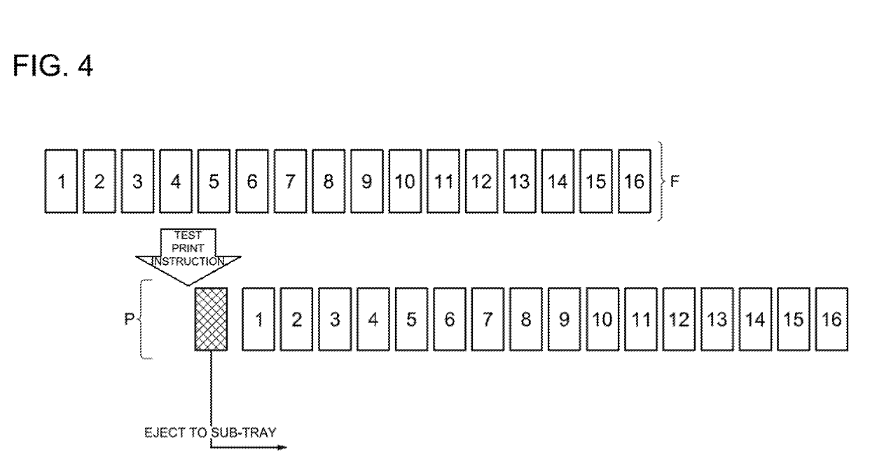

FIG. 4 shows an exemplary automatic test print by “before job start output”. An upper array F in the figure is document image to configure job and the lower array P shows sheets after image forming to be outputted. Numbers in the document images and in the sheets indicate image numbers. In the example, the job is configured with 16 pages of the document images, number of copy is one, and single-sided print mode is set. In the “before job start output”, before the ordinary print based on a job is started, test print (shaded sheets in the figure) is carried out.

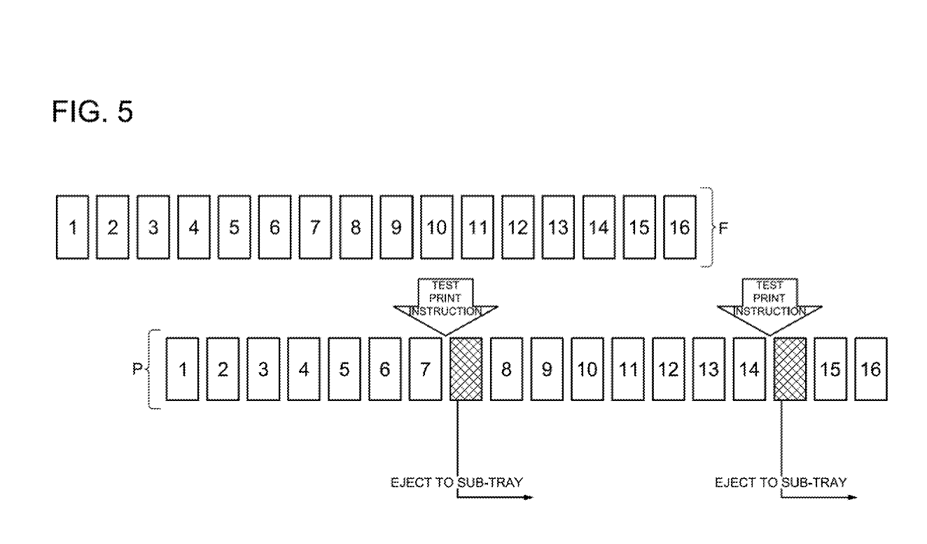

FIG. 5 shows an exemplary automatic test print at each designated sheet number. Here, the designated sheet number is set to be seven thus the test print is carried out every time when seven sheets of ordinary print is completed.

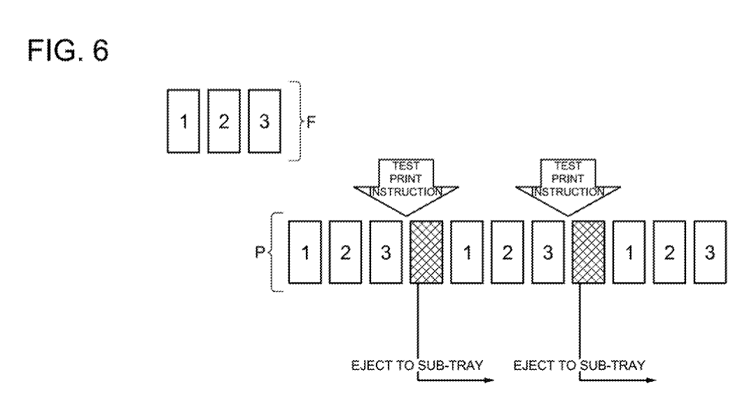

FIG. 6 shows an exemplary automatic test print by “output at sectional deliminater”. The document image configuring one print set includes 3 pages, number of print sets is three and single-sided print mode is set. Each test print is carried out between the first set and the second set, and second set and third set using the designated image.

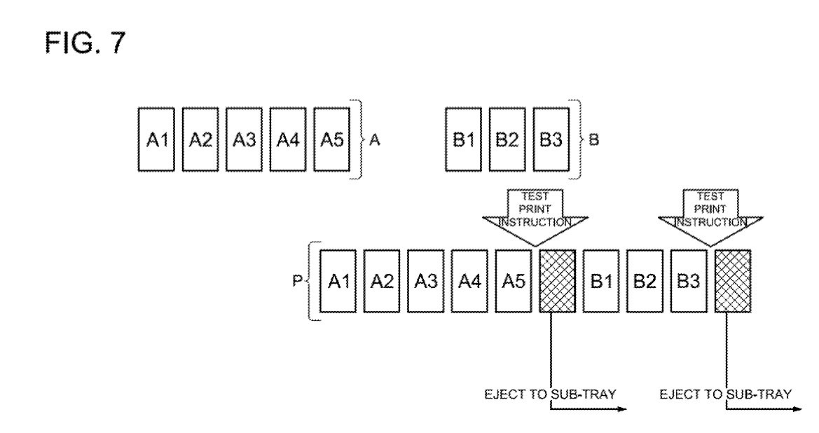

FIG. 7 shows an exemplary automatic test print by “after job complete output”. The document image of a job A is configured with five pages (A1 to A5), the number of print sets is one and the single-sided print mode is set. The document image of a job B executed subsequent to the job A is configured with three pages (B1 to B3), the number of print sets is one and the single-sided print mode is set. In the example, ordinary print by the job A is carried out, then after completion of the job A, test print is carried out and then the ordinary print by the job B is further carried out. Then after completion of the job B, test print is carried out.

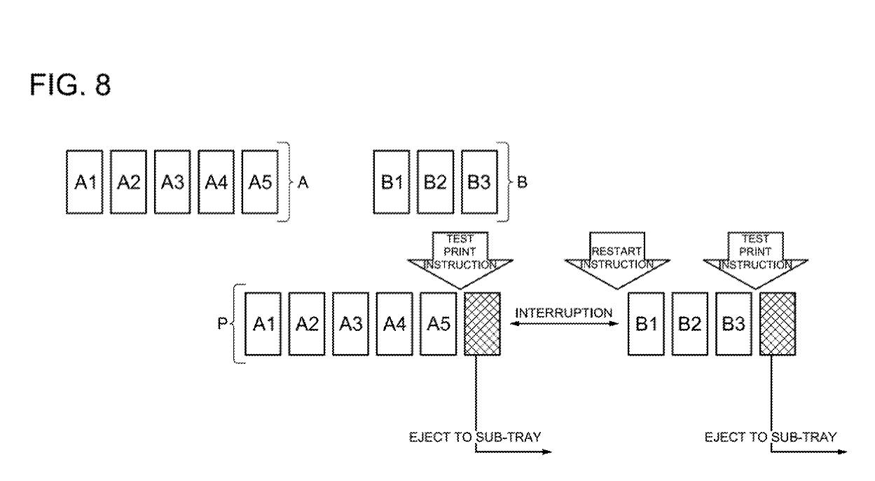

FIG. 8 shows an exemplary output in an operation mode in which after test print, ordinary print is ceased once, then when a re-start instruction (for example, pressing a start button) is received, the ordinary print is started again. The user can start the ordinary print again upon visual confirmation of the image of test print.

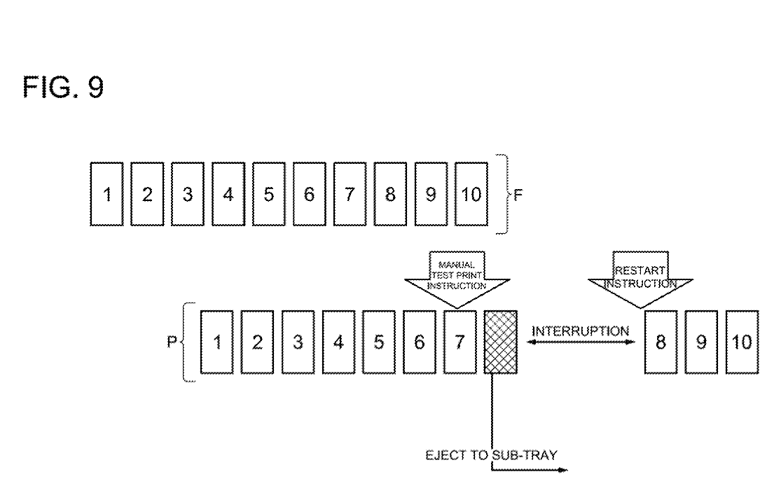

FIG. 9 shows an exemplary manual test print. The job is configured with document image of 10 pages, the number of print sets is one and single-sided print mode is set. When an execution instruction of manual test print is received during ordinary print of page 6^{th}, a predetermined image for the manual test print is formed on the subsequent sheet, and the sheet is test printed to the sub-tray 43. In the example, the ordinary print is interrupted after test print, and when a re-start instruction from the user is received, the ordinary print is stared again.

A flow of operation in which the user register an discretionary image as the image for the test print (test print image) will be described as follow.

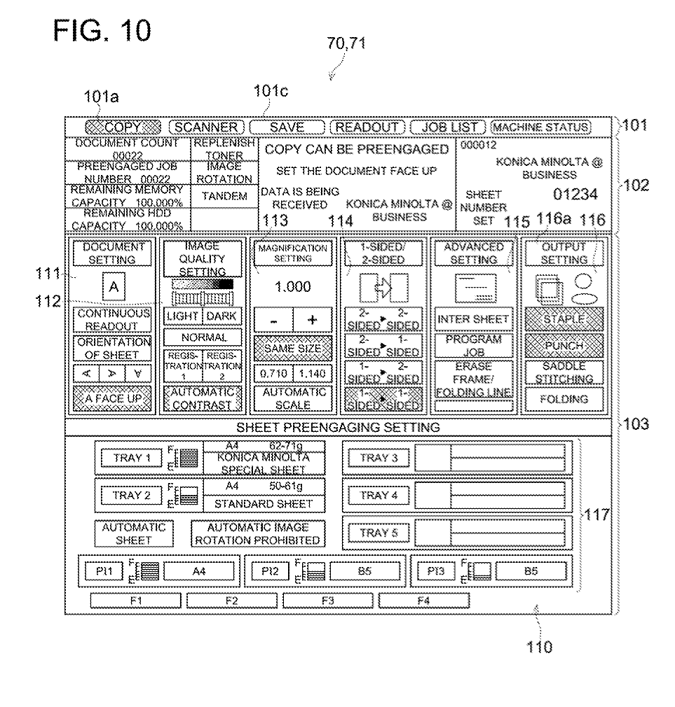

FIG. 10 shows an exemplary screen displayed on the display section 71 of the operation display section 70. At an upper area of each screen displayed on the display section 71, there are always displayed tag buttons 101 disposed in a single horizontal raw and a basic information display section 102 to display basic information of a current state of the image forming apparatus 3. Bellow the basic information display section 102, a general-purpose display area 103 used to displays various screens is provided. The screens displayed in the general-purpose display area can be changed by pressing one of the tag buttons 101. FIG. 10 shows a state where a copy basic screen 110 is displayed in the general-purpose display area 103 by operating the tag button 101a for copy.

In the copy basic screen 110, setting columns for a document setting 111, image quality setting 112, magnification setting 113, one-sided/two-sided setting 114, advanced setting 115, output setting 116 and sheet setting 117 are provided. In each of setting columns 111 to 117, the current setting details for each setting item are displayed besides guide information for setting and operation buttons.

For example, in the document setting, setting for document read method (consecutive/single piece) and setting for orientation of the document placed at the scanner section 11. Also, in the sheet setting column 117, sizes, weighting capacity, remaining amount of the sheet set in each tray provided in the image forming apparatus 3 are displayed. The sheet trays can be selected by pressing a tray number display portion.

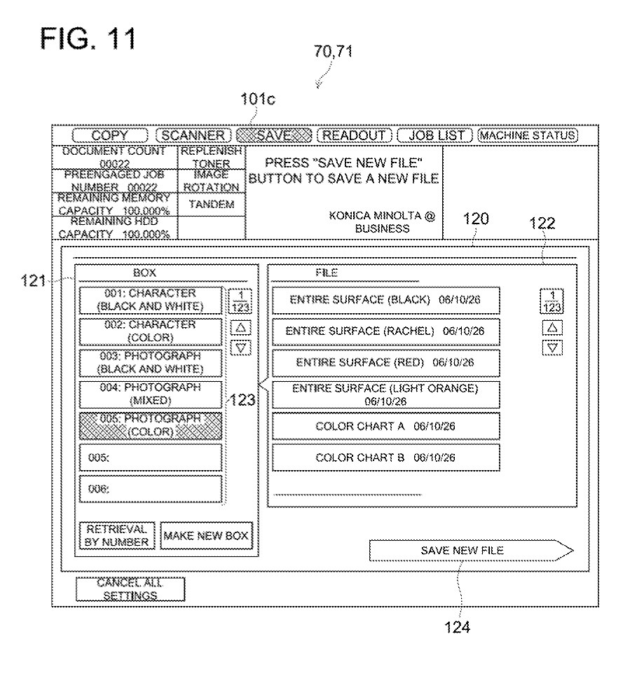

To register the test print image, a storage tag 101c in the tag buttons 101 is operated. By this operation, an unillustrated storing screen is displayed. Further, by operating an unillustrated sample image register button in the screen, a box selection screen 120 shown by the FIG. 11 is displayed.

In the box selection screen 120, a box display column 121 and a file display column 122 are provided. In the box display column 121, there are displayed box selection buttons 123 corresponding to each box formed in advance so as to register the test print image. The box means an imaginable container provided in the memory device 69 to sort and register the images (image files). The user can newly create the boxes and delete them and can register the image files in each box. Also, a box number is assigned to each box and the user can give a discretionary name to each box. In the file display column 122 a list of file names of the image files stored in the box selected in the box display column 121 is displayed.

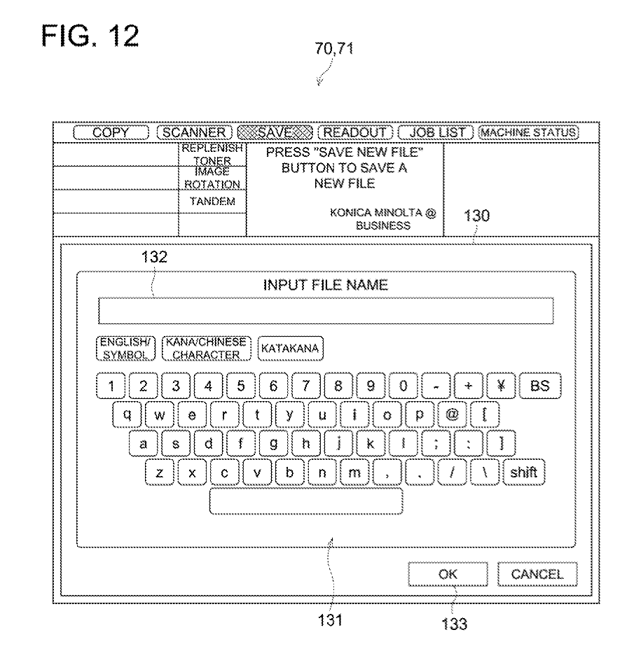

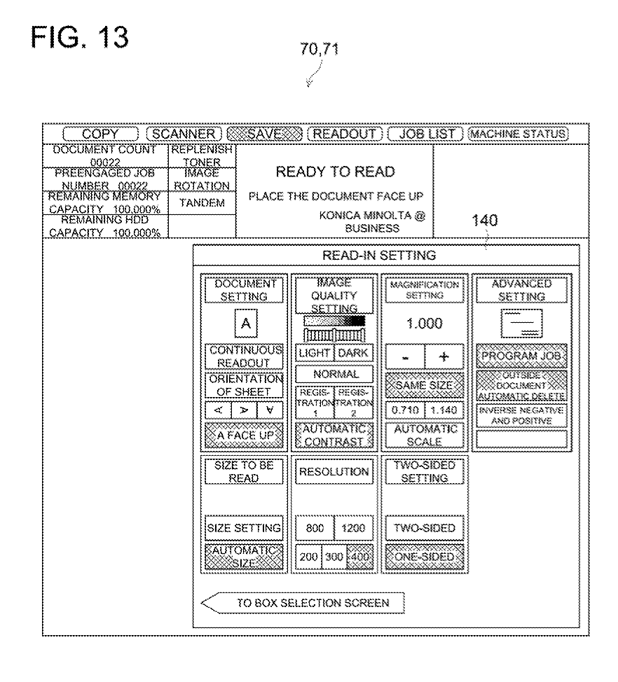

When a new file storing button 124 at a right lower area of the screen is operated in a state where any one of the box selection buttons 123 is being selected, a file name input screen 130 shown in FIG. 12 is displayed. In the file name input screen 130, a key board 131 to input characters and symbols are displayed schematically. The user operates the key board 131 to input the file name into the input column 132. By operating an OK button 133, the file name is fixed, and a read-in setting screen 140 shown in FIG. 13 is displayed.

After setting a document to be register as the test print image at the scanner section 11, various settings related to document read-in are carried out in the read-in setting screen 140, then by pressing an unillustrated start button, the image of the document is read by the scanner section 11. A corresponding image data is stored in the box selected in the box selection screed 120 to be an image file with a file name set in the file name input screed 130. When read-in of the image is completed, the display automatically returns to the box selection screen 120 where the user can continue to register the test print image.

In the image forming apparatus 3, as above, the discretionary image can be registered in the selected box as the test print image. Further a print image registration function where the image processing section 80 expands print data received from the external terminal 2 to be a raster image, and the obtained raster image is stored and registered in the selected box as a test print image. Operation related to the print image registration function is carried out through the setting screen (not illustrated) of a printer driver of the external terminal side 2. For example, selection of the page number whose print data is registered as the test print image and the box representing a destination of registration, and setting of the file name to be registered are carried out.

Incidentally, in the above example, the test print image is stored in the box exclusive for the test print image which is different from the box to store other general images, it can be configured so that the test print image is registered in the box for general image or the test print image is registered in the general box to store discretionary images.

Next, test print setting carried out when copy job is inputted will foe described.

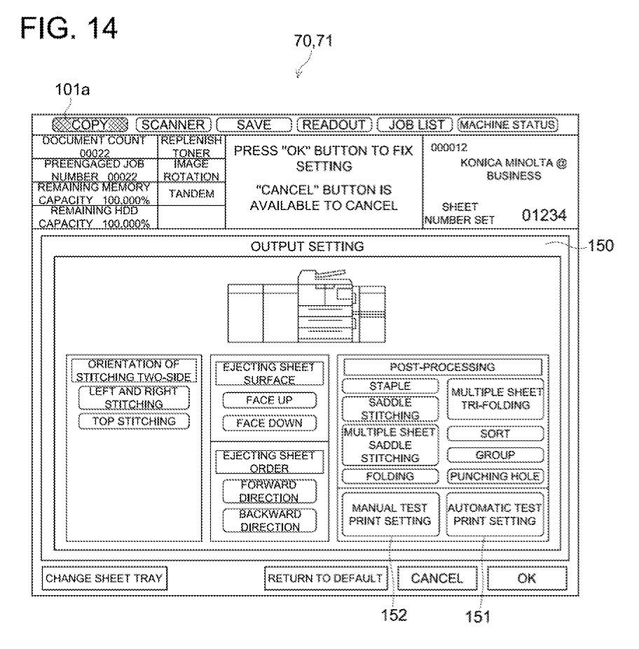

To carry out test print setting, an output setting selection button 116a of the output setting column 116 in the copy basic screen 110 shown by FIG. 10 is operated. Thereby the output setting screen 150 shown in FIG. 14 is displayed in the display section 71. In the output setting screen 150, setting item selection buttons related to stitching directions of the sheet, ejection surface of the sheet, and post-processing are displayed. At lower right portion of the output setting screen 150, there are displayed an automatic test print setting button 151 to conduct setting for automatic test print where the apparatus automatically judges an execution timing of test print, and a manual test print setting button 152 to conduct setting for manual test print where the test print is executed when the execution instruction from the user is received.

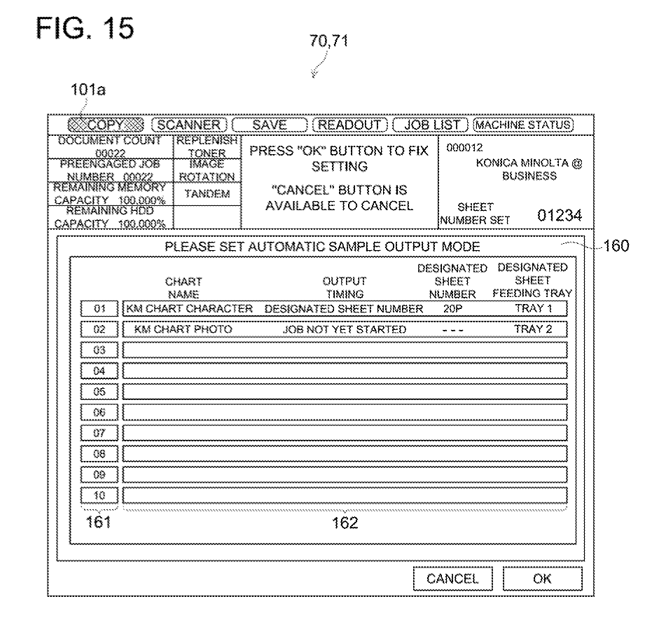

When the automatic test print button 151 is operated, a test print setting screen 160 shown in FIG. 15 is displayed. In the present image forming apparatus 3, a plurality of sets of test print conditions to designate the execution timing of the test print (output timing and designated sheet number), the image (chart) utilized in the test print and a supply source (designated sheet feeding tray) of the sheet used for the test print can be set for each job. In the test print setting screen 160, a number button 161 indicating an identification number of the test print condition and a setting detail display column 162 to indicate content of test print condition of each number are displayed in relation to each other. In an example shown by FIG. 15, two test print conditions No. 1 and No. 2 are set.

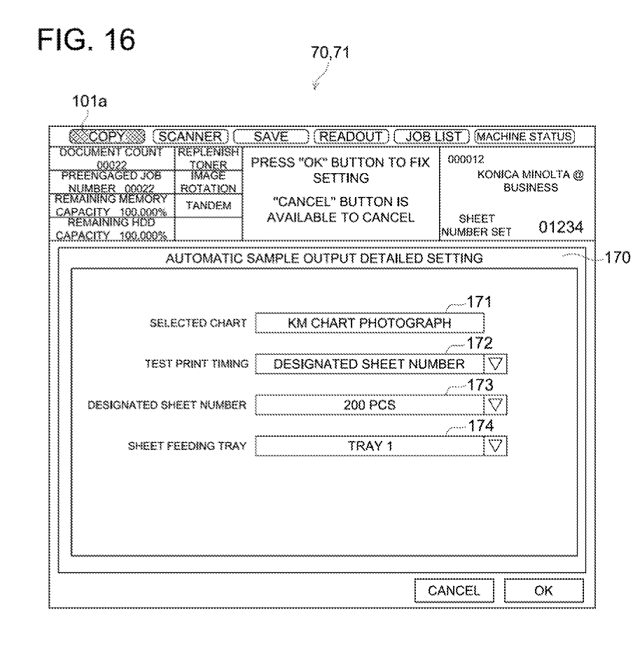

By operating one of the number buttons 161, a detail setting screen 170 to set the test print conditions corresponding to the number thereof is displayed on the display section 71 (refer to FIG. 16). In the detail setting screen 170, there are displayed a chart column 171 in which a chart name of the test, print image is displayed, a test print timing setting column 172 to the select the test print timing, a designated sheet number setting column 173 to set the designated sheet number and a sheet feeding tray setting column 174 to set the sheet feeding tray.

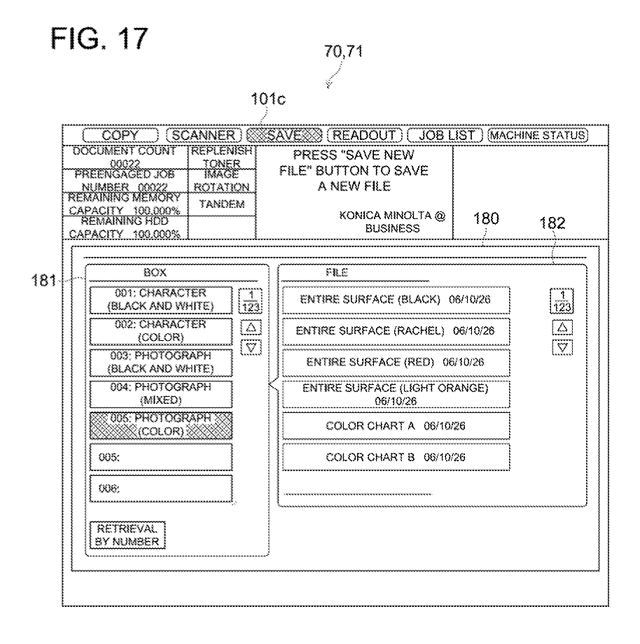

The chart column 171 is commonly used as an operation button as well. By pressing the chart column 171, a chart selection screen 180 shown in FIG. 17 is displayed. The chart selection screen 180 is provided with the box display column 181 and the file display column 182 in the same manner as the box selection screen 120 in FIG. 11 and configured so that the test print image is selected by selecting one of the boxes in the box display column 181 and by further selecting one of the image files in the box in the file display column 182.

In the test print timing setting column 172 of the detail setting screen 170 in FIG. 16, setting can be selected in the following options.

“Non” . . . Automatic test print mode off

“Before job start” . . . The test print is executed before job starts (before job start output).

“Designated sheet number” . . . The test print is executed every time the number of the sheets are outputted in the ordinary print, where the number is set in the designated sheet number setting column (output at each designated sheet number).

“Sectional deliminater” . . . The test print is executed at section deliminaters (output at sectional deliminater).

“Job completion” . . . The test print is executed when the job is completed (After job complete output).

In the designated sheet number setting column 173, discretionary numbers in a range of 1 to 9999 can be set. In the sheet feeding tray setting column 174, the number of sheet feeding tray (tray 1 or tray 2) or the same sheet feeding tray as that in the ordinary print can foe set.

As FIG. 15 shows, in case a plurality of test print conditions are set for one job, the test print is executed in accordance with each test print conditions set therein. For example, in case a first test print condition is set as “test print image: chart A, designated sheet number: 50 pieces” and a second test print condition as “test print image: chart B, designated sheet number: 100 pieces”, the chart A is test printed in accordance with the first test print condition at 50^{th} sheet of ordinary print by the job, and the chart A is test printed in accordance with the first test print condition at 100^{th} sheet of ordinary print and further the chart B is test printed in accordance the second test print condition. Meanwhile, it can be configured so that a plurality of test print images can be designated under one sample condition.

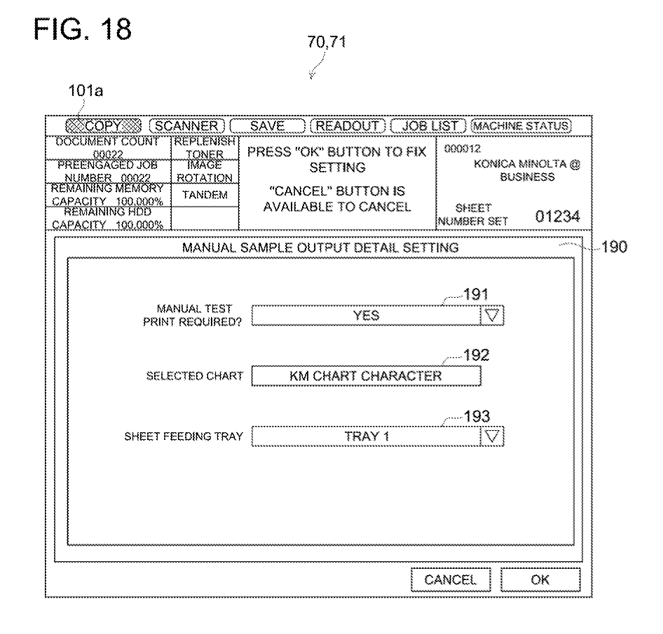

In case the manual test print setting button 152 is operated in the output setting screen 150 of FIG. 14, the manual test print detail setting screen 190 shown in FIG. 18 is displayed on the display section 71. In the manual test print detail setting screen 190, there are displayed a manual test print requirement setting column 191 which sets whether manual test print is required or not, a chart column 192 in which the chart name selected as the test print image is displayed and a sheet feeding tray setting column 193 to set the sheet feeding tray.

In the manual test print requirement setting column 191, either options “Yes” to enable the manual test print or “No” to disable it can be selected. Since the chart column 192 and the sheet feeding tray setting column 193 are the same as the chart column 171 and the sheet feeding tray setting column 174 in FIG. 16, descriptions are omitted.

In the manual test print requirement setting column 191, if “Yes” is selected, a manual test print button 201 is displayed in a screen of “during printing 200” which is displayed during a job accompanied by ordinary print. The user can manually send an execution instruction of the test print by operating the manual test print button 201 at a discretionary time point during printing, and the test print is executed onto an immediately subsequent page. In case “No” is selected in the manual test print requirement setting column 191, the manual test print button 201 is not displayed in the screen of “during printing 200”, and the execution instruction of manual test print can not be sent.

Next, an operation flow of the image forming apparatus 3, from reception of the job accompanied by the ordinary print to completion of the output will be described.

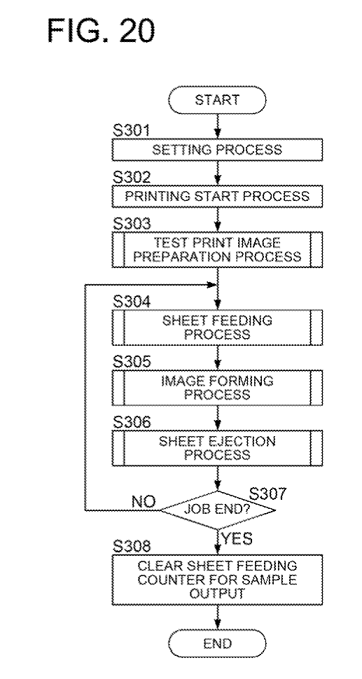

FIG. 20 shows an entire flow of the above operation. First, various settings related to the job input is conducted by the user (Step 3301). In the setting, setting of test print conditions described in the forgoing is carried out. After completion of setting, when an unillustrated start button is pressed, various preparation processes to start job execution is carried out (Step S302). Also, preparation processing of the image for the automatic test print and the image for the manual test print is carried out (Step S303).

Thereafter, a sheet feeding process (Step S304), an image forming process (Step 3305), and a sheet ejection process (Step S306) are repeatedly executed until the job is completed (Step 3307;N) and when the job is completed (Step S307;Y), a sheet feeding counter for the test print is reset

(Step S308) and the process is terminated.

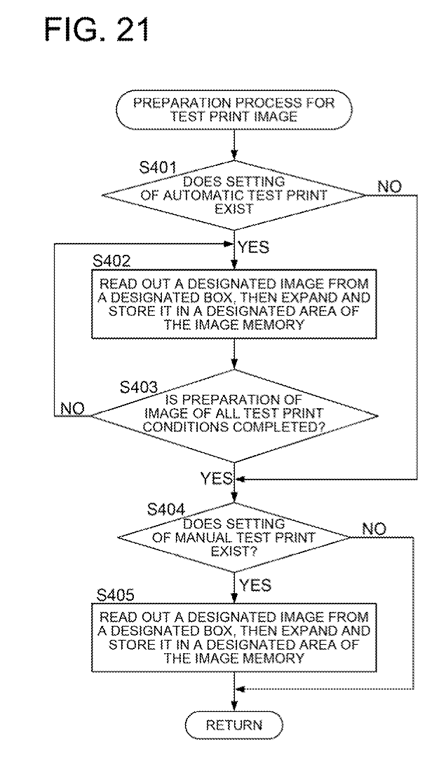

FIG. 21 shows detail of a test print image preparation process (S303 of FIG. 20). In case setting of the automatic test print is conducted when the job is inputted (Step S401; Y), a header and image data of the image (chart) designated by the test print condition, set therein are read out from the memory device 69 and expanded by the expansion IC 63b and then stored in a predetermined area of the page memory 65a (Step S402). This is carried out for all the test print conditions set in respect to the job thereof (Step S403; N).

In case the above image preparation is completed for all the test print conditions (Step S403; Y), or the automatic test print is not set (Step S401; N), whether or not the manual test print is set to be “Yes” is verified (Step S404). In case the manual test print is not set to be “Yes” (Step S404; N), processing is terminated. In case manual test print is set to be “Yes”, (Step S404; Y), the header and the image data of the image (chart) having been set for the manual test print is readout form the memory device 69 and expanded by the expansion IC 63b and then stored in a predetermined area of the page memory 65a (Step S405), thereafter present processing is terminated.

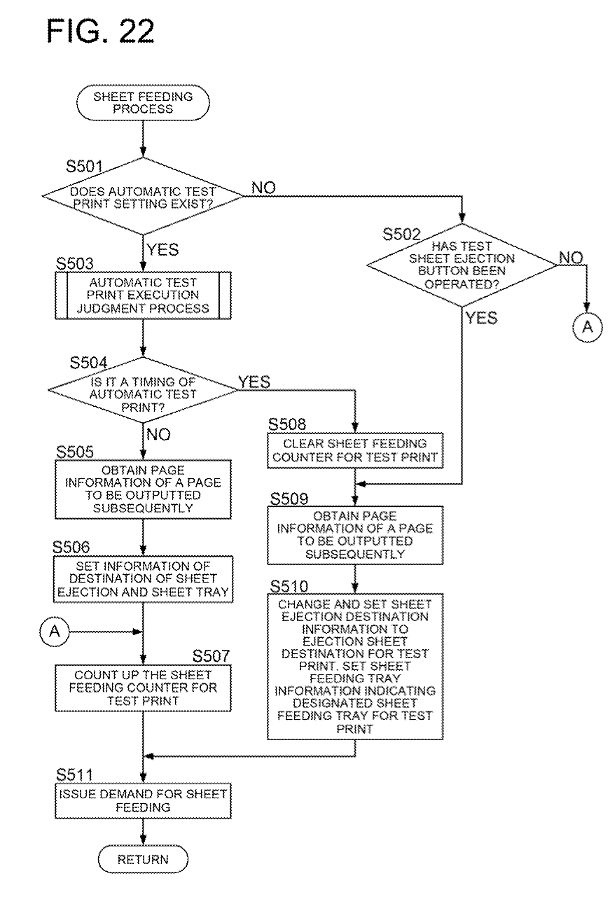

FIG. 22 shows a flow of a sheet feeding process (FIG. 2, S304). Whether or not the automatic test print is set is verified (Step S501), and if the automatic test print is set, there is carried out automatic test print execution judgment processing so as to verify whether or not an execution timing of the automatic test print has been arrived (Step S503).

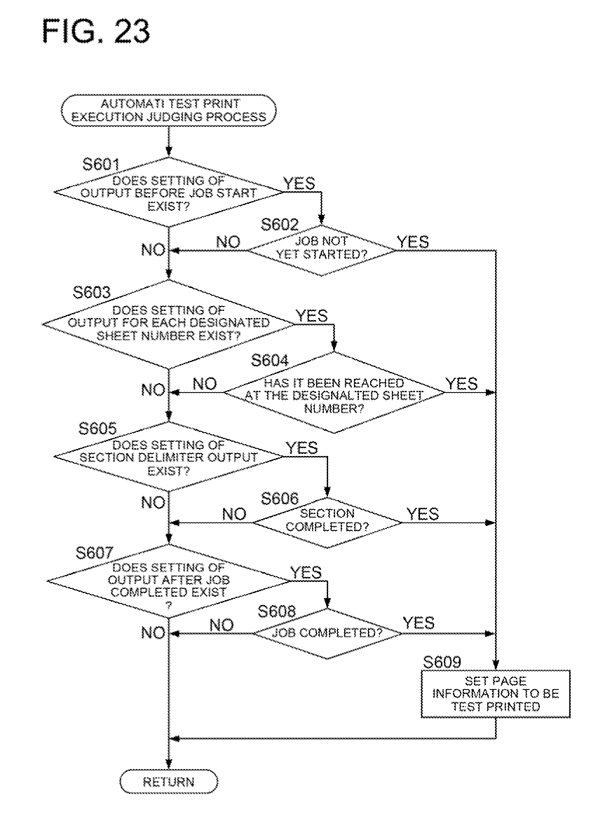

FIG. 23 shows detail of the automatic test print execution judging processing (S503 of FIG. 2). In case “before job start output” is set ((Step S601; Y) and a current state is before the job starts (Step S602; Y), or in case “output at each designated sheet number” is set (Step S603; Y) and the number of outputted sheets has been reached to the designated number (namely, a value of the sheet feeding counter for the test print is the designated number, Step S604; Y), or in case “output at sectional deliminater” is set (Step S605;Y) and a part of the ordinary print has been completed in a current, state (Step S606; Y), or in case “output after job complete” is set (Step S607; Y) and the job is completed in a current state (Step S608; Y), information indicating the execution timing of the automatic test print has been arrived and information necessary for the test print are set in an predetermined area (page information area) in a memory (memory device 69) (Step S609). For example, an storing address of image data (corresponding data among data prepared in former step of S303) to be used current test print and information of the sheet tray are set and the present processing is terminated (return). If the foregoing is not the case, the execution timing of the test print is judged to have reached and the present processing is terminated (return).

Returning to FIG. 22 to continue description. In case the execution timing of automatic test print has not been reached (Step S504; N), page information (information indicating a page on which the image to be outputted exists and information telling the sheet feeding tray and the sheet ejection destination) about a page on which image forming is to be carried out next in the job is obtained (Step S505), and the sheet ejection information thereof and the sheet feeding tray information are set in an area to exchange information with a predetermined module in charge (Step S506), and the sheet feeding counter for the test print is incremented (Step S507), a sheet feeding demand is issued to each section where sheet feeding processing is actually carried out (Step S511) and the processing is terminated (return). Thereby, the sheet is fed from the sheet feeding tray indicated in the area for exchanging information and the designated image is formed on the sheet (S305 of FIG. 20), then the sheet is ejected to the designated sheet ejection destination(S306 in FIG. 20).

When the execution timing of the automatic test print reaches (Step S504; Y), the sheet feeding counter for test print is reset (Step S508), subsequently the page information (information indicating the test print image and the sheet feeding tray of the sheet to which the sample is outputted) of the page (page for the test print) is obtained from the aforesaid area for exchanging information (Step S509). Then the sheet ejection information is modified to designate the sheet: ejection destination for the test print (sub-tray 43) and set in the area, for exchanging information with the predetermined module in charge and also the sheet feeding tray information, corresponding to the designated test print sheet feeding tray is set in the area for exchanging information with the predetermined module in charge (Step S510). Thereafter, the sheet feeding demand is issued to each section where sheet feeding processing is actually carried out (Step S511) and the processing is terminated (return).

Thereby, the sheet is fed from the sheet feeding tray for the test print designated in the area for exchanging information and the designated test print image is formed on the sheet (S305 of FIG. 20), then the sheet is ejected to the designated sheet ejection destination (sub-tray 43) (S306 of FIG. 20), thus the test print is completed.

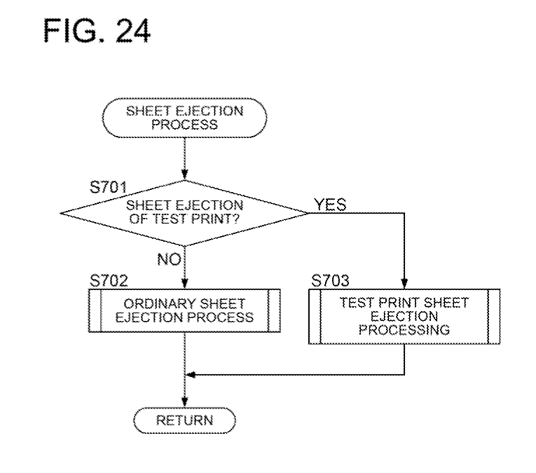

FIG. 24 shows a flow of sheet ejection processing (FIG. 20, S306). Whether or not the sheet currently ejected is for the test print is judged (Step S701), if the sheet ejection is not for the test print (Step S701; N), ordinary sheet ejection processing is carried out (Step S702) and the processing is terminated (return). Sheet ejection in the ordinary sheet ejection processing is carry out, for example, with the main stacker section 41 as the sheet ejection destination. Also, various kinds of processing for completion of the sheet ejection in ordinary print are carried out, for example, the processed page by the job is advanced by one page. In case of sheet ejection of the test print (Step S701; Y), test print sheet ejection processing is carried out (Step S703) to terminate the processing (return). In the test print sheet ejection processing, sheet ejection is carried out with the sub-tray 43 as a sheet ejection destination.

As above, in the image forming apparatus 3, since the user can register a discretionary image as an image for test print, an original test chart to suit items which the user desires to confirm can foe outputted, and compared to a case where a fixed chart provided by a maker is used, the test print satisfying demands of the user can be attained. Also, for the user who requires to check only taint of the sheet by the test print, an image to suit the purpose can be outputted in the test print, and a problem that toner consumption is increased and wasted by outputting a complicated fix test pattern is solved.

Further, since the test print conditions can be set respectively for the jobs, a chart to suit an output image of each job can be outputted. Also, since a plurality of sets of test print conditions can be set for one job, the test print can be carried out with a complicated output form thereby being able to cope with demands of various users. Also since an image for the manual test print can be set besides the automatic test print, for example, it can cope with such a demand that a simple chart is outputted in the automatic test print for examining taint of the image and a complicated chart is outputted in the manual test print so as to examine various items of image quality using a complicated

In the forgoing, while the embodiments of the present invention have been described with reference to the drawings, it is understand that practical configurations are not restricted to the embodiments indicated therein and changes and variations may be made without departing from the spirit or scope of the invention.

For example, in the embodiment, while the test print setting is received when the job is inputted, it can be received at other timing. For example, in a preengaged job, the setting can be carried out during a waiting time for the job. Also, apart from the job, automatic test print setting and manual test print setting can be registered per the image forming apparatus 3 or per the user. For example, in case of by the user, it can be configured that when the user is authenticated, automatic test print setting and manual setting having been registered to foe corresponded to the user become available.

In the embodiment, while the image inputted from the scanner section 11 is stored and registered in the box for the test print, the image for test print can be memorized and managed without using the box.

Also, in the embodiment, while the main stacker section 41 of the stacker device 7 is assigned as the destination of sheet ejection for ordinary print, and the sub-tray 43 is assigned as the sheet ejection destination for the test print, the sheet ejection destinations are not restricted to the destinations thereof as far as the destination for the ordinary print and the destination of the test print differ. In case the destination of the ordinary print is in the stacker device and the image cannot be observed, the present invention becomes more effective, however, the present invention is not restricted the above configuration. Also, in the above embodiment, while the image forming apparatus main body 5 and the stacker device 7 are configured as the separate apparatuses, they can be configured in one unit.

The image forming apparatus is not restricted to the multifunction peripherals having various functions indicated in the embodiments. It can be a digital copying machine having only copying function or printer device having only printing function.

According to the present invention, the test print can be carried out utilising a discretionary image desired by the user.

What is claimed is;

1. An image forming apparatus, comprising;
an image forming section to form and output an image on a sheet;
a first sheet ejection section to receive the sheet outputted from the image forming section;
a second sheet ejection section to receive the sheet outputted from the image forming section;
an ejected sheet destination changeover section to change a destination of an ejected sheet from the image forming section between the first ejection section and the second ejection section;
an image input section to input an image used in the test print;
a memory section to store the image inputted through the image input section;
a selection section to select the image used in the test print among the images stored in the memory section; and
a control section to control ordinary print where the sheet on which the image has been formed is ejected to the first sheet ejection section and test print where the image selected by the selection section is formed on the sheet and the sheet thereof is ejected to the second sheet ejection section before, during or after consecutive ordinary print.

2. The image forming apparatus of claim 1, wherein the selection section receives a plurality of settings of test print conditions which at least designate an execution timing of the test print and the image to be used in the test print for each job to conduct the ordinary print, and the control section conducts the test print according to each of the plurality of test print conditions having been set.

3. The image forming apparatus of claim 1, further comprising:
an instruction receiving section to receive an execution instruction of the test print from a user;
wherein among the images stored in the memory section, the selection section selects the image to be used in the test print based on the execution instruction, and the control section conducts the test print using the image selected by the selection section as the image used in the test print based on the execution instruction when the execution instruction is received.
